(19) United States
(12) Patent Application Publication
(10) Pub. No.: US 2019/0197167 A1
(43) Pub. Date: Jun. 27, 2019

(54) DEPTH-DATA SEGMENTATION

(71) Applicant: Ford Global Technologies, LLC, Dearborn, MI (US)

(72) Inventors: Arpan Kusari, East Lansing, MI (US); Thomas Ackenhausen, Ann Arbor, MI (US)

(73) Assignee: Ford Global Technologies, LLC, Dearborn, MI (US)

(21) Appl. No.: 15/850,528

(22) Filed: Dec. 21, 2017

(51) Int. Cl. G06F 17/30

(52) U.S. Cl. CPC G06F 17/30548; G06K 9/00201; G06F 17/30961

(57) ABSTRACT

An imaging system is described, as well as methods of using the system. A method may include: parsing a grid-tree data structure for a plurality of previously-evaluated elevation points; determining that none of the plurality are within a radius of a currently-evaluated elevation point; and then, generating a new segment comprising the currently-evaluated elevation point.

### BACKGROUND

One technique for sorting point-cloud data obtained from light detection and ranging (LIDAR) devices is voxelizing. Voxelizing can require substantial time to sort and aggregate point-cloud data. In some examples, the voxelizing process may be too slow or cumbersome for environments which can change rapidly and wherein a rapid response to such changes are desirable.

### BRIEF DESCRIPTION OF THE DRAWINGS

FIG. 1 is a perspective view of a vehicle having an imaging system that comprises a light detection and ranging (LIDAR) device.

FIG. 2 is a schematic diagram of some exemplary components of the imaging system.

FIG. 3 is a diagram illustrating a grid-tree structure.

FIGS. 4-6 illustrate different vantage-point tree diagrams.

FIG. 7 is a schematic view illustrating the imaging system merging two LIDAR segments.

FIG. 8 illustrates a flow diagram of a segmentation process—organizing point-cloud data into LIDAR segments and aggregating the LIDAR segments into virtual objects representative of physical objects scanned by the imaging system.

### DETAILED DESCRIPTION

An imaging system for a vehicle is described that includes a computer and at least one depth-detection device (e.g., such as a light detection and ranging device). In addition, one or more methods of using the system are also described. According to one illustrative example, a method may comprise: parsing a grid-tree data structure for a plurality of previously-evaluated elevation points; determining that none of the plurality are within a radius of a currently-evaluated elevation point; and then, generating a new segment comprising the currently-evaluated elevation point.

According to the at least one example set forth above, the plurality and the currently-evaluated elevation point are received from a light detection and ranging device.

According to the at least one example set forth above, further comprising: adding the new segment to the grid-tree data structure.

According to the at least one example set forth above, further comprising generating a depth-data packet that comprises a parsable key, an x-coordinate value and a y-coordinate value of the currently-evaluated elevation point, and a segment identifier of the new segment.

According to the at least one example set forth above, further comprising locating the depth-data packet into the data structure using the parsable key, wherein the data structure comprises a hash map.

According to the at least one example set forth above, each of the plurality comprise: a hash value, an x-coordinate value, a y-coordinate value, and a segment identifier.

According to the at least one example set forth above, the data structure is a quad-tree data structure.

According to another illustrative example, a method includes: parsing a grid-tree data structure for a plurality of previously-evaluated elevation points; determining that one of the plurality are within a radius of a currently-evaluated elevation point, wherein the one comprises a first segment identifier; and then, tagging the currently-evaluated elevation point with the first segment identifier.

According to the at least one example set forth above, the plurality and the currently-evaluated elevation point are received from a light detection and ranging device.

According to the at least one example set forth above, further comprising generating a depth-data packet that comprises a parsable key, an x-coordinate value and a y-coordinate value of the currently-evaluated elevation point, and the first segment identifier.

According to the at least one example set forth above, further comprising locating the depth-data packet into the data structure using the parsable key, wherein the data structure comprises a hash map.

According to the at least one example set forth above, each of the plurality comprise: a hash value, an x-coordinate value, and a y-coordinate value, wherein at least one of the plurality includes the first segment identifier.

According to the at least one example set forth above, the parsing comprises processing only occupied nodes.

According to the at least one example set forth above, the data structure is a quad-tree data structure.

According to another illustrative example, a method includes: parsing a grid-tree data structure for a plurality of previously-evaluated elevation points; determining that a first point and a second point of the plurality are within a radius of a currently-evaluated elevation point, wherein the first point comprises a first segment identifier, wherein the second point comprises a second segment identifier; merging segments associated with the first and second points; and adding the currently-evaluated elevation point and a new identifier of the merged segment to the data structure.

According to the at least one example set forth above, the plurality and the currently-evaluated elevation point are received from a light detection and ranging device.

According to the at least one example set forth above, further comprising generating a depth-data packet that comprises a parsable key, an x-coordinate value and a y-coordinate value of the currently-evaluated elevation point, and the new identifier.

According to the at least one example set forth above, further comprising locating the depth-data packet into the data structure using the parsable key, wherein the data structure comprises a hash map.

According to the at least one example set forth above, each of the plurality comprise: a hash value, an x-coordinate value, and a y-coordinate value, wherein others of the plurality include a third segment identifier that is different from the first and second identifiers.

According to the at least one example set forth above, the parsing comprises processing only occupied nodes.

According to the at least one example, a computer is disclosed that is programmed to execute any combination of the examples of the method(s) set forth above.

According to the at least one example, a computer program product is disclosed that includes a computer readable medium that stores instructions executable by a computer processor, wherein the instructions include any combination of the examples of the method(s) set forth above.

Turning now to the figures wherein like reference numerals denote like or similar elements, features or functions, an autonomous driving system 10 for a vehicle 12 is shown. The autonomous driving system 10 may include an imaging system 14 that comprises a computer 20 and at least one depth-detection device 22 (e.g., such as a light detection and ranging (LIDAR) device). Computer 20 may receive a point-cloud data set from the depth-detection device 22 and may parse and sort this data set so that vehicle 12 may determine situational awareness and be capable of navigating in an autonomous driving mode. More particularly, according to a process commonly referred to as segmentation, computer 20 may analyze and organize this point-cloud data (scanned by the device 22) into virtual objects representative of physical or actual objects in the real world (e.g., around vehicle 12). According to one technique described herein, computer 20 may execute instructions that utilize both a vantage-point tree data structure and a grid-tree data structure in order to reconstruct the virtual object(s). Using this hybrid vantage-point tree/grid-tree approach, computer 20 may be able to reconstruct the virtual object faster and more efficiently than by using only a grid-tree data structure, only a vantage-point tree (or metric) data structure, or only some other data structure. Following an exemplary description of the autonomous driving system 10, one or more methods of using the system 10 and/or system 14 will be described.

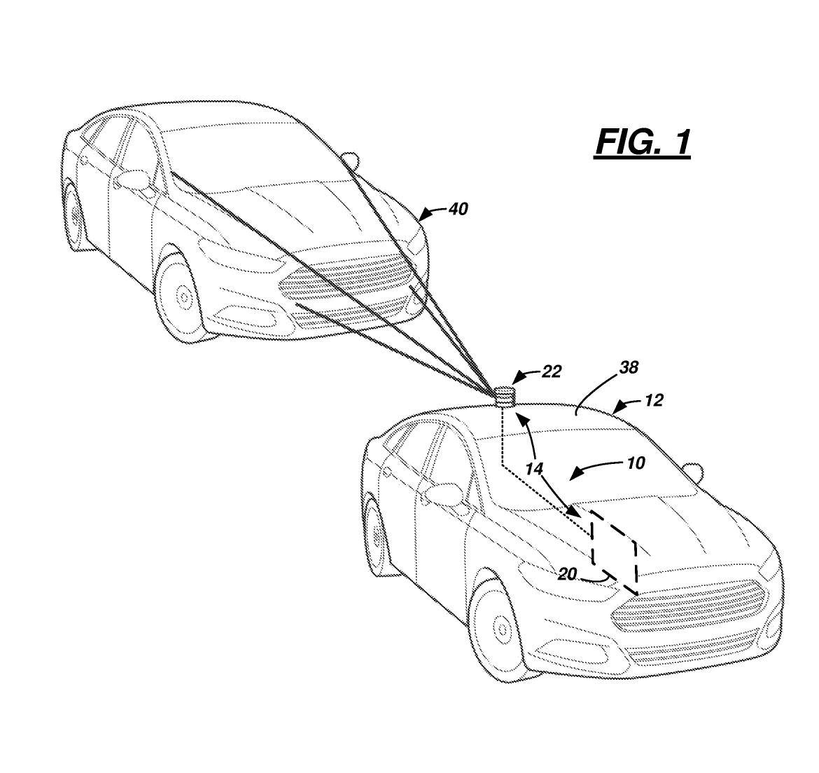

FIG. 1 illustrates vehicle 12 as a passenger vehicle; however, vehicle 12 could be any other suitable vehicle type, including a truck, a sports utility vehicle (SUV), a recreational vehicle, a bus, aircraft, marine vessel, or the like that comprises the autonomous driving system 10 and/or imaging system 14. System 10 may facilitate operation of the vehicle 12 in one or more autonomous modes, as defined by the Society of Automotive Engineers (SAE) (which has defined autonomous vehicle operation at levels 0-5). More particularly (and as described in greater detail below), system 10 may comprise one or more onboard computers configured to store and execute logic instructions or sets of instructions embodied in hardware, software, firmware, a combination thereof, or the like to thereby enable vehicle 12 to operate with some user assistance (partial autonomy) or without any user assistance (full autonomy). For example, at levels 0-2, a human driver monitors or controls the majority of the driving tasks, often with no help from the vehicle 12. For example, at level 0 (“no automation”), a human driver is responsible for all vehicle operations. At level 1 (“driver assistance”), vehicle 12 sometimes assists with steering, acceleration, or braking, but the driver is still responsible for the vast majority of the vehicle control. At level 2 (“partial automation”), vehicle 12 can control steering, acceleration, and braking under certain circumstances without human interaction. At levels 3-5, vehicle 12 assumes more driving-related tasks. At level 3 (“conditional automation”), vehicle 12 can handle steering, acceleration, and braking under certain circumstances, as well as monitoring of the driving environment. Level 3 may require the driver to intervene occasionally, however. At level 4 (“high automation”), vehicle 12 can handle the same tasks as at level 3 but without relying on the driver to intervene in certain driving modes. At level 5 (“full automation”), vehicle 12 can handle all tasks without any driver intervention.

In at least one example, the one or more computers of autonomous driving system 10 of vehicle 12 each may have at least one processor and/or memory, wherein the respective processor(s) execute instructions stored in respective memories that facilitate driving the vehicle 12 in one or more of the autonomous modes described above. Computer 20 may store and execute these autonomous driving instructions; however, in other examples, computer(s) (not shown) may store and execute such autonomous driving instructions (e.g., computer 20 could be dedicated to imaging system 14). According to at least one example, using system 10, vehicle 12 is operational according to SAE levels 3, 4, and/or 5; and in at least one example, the autonomous driving system 10 facilitates operation of vehicle 12 at fully autonomy (e.g., level 5).

Turning now to imaging system 14, the system 14 may comprise any components adapted to receive depth-detection data and analyze, sort, aggregate, and/or utilize such data. As described above, system 14 comprises at least one computer (e.g., computer 20) and at least one depth-detection device 22. Computer 20 may be dedicated to imaging system tasks; in other examples, computer 20 may be shared with other vehicle functions or configured, programmed, etc. to carry out other tasks.

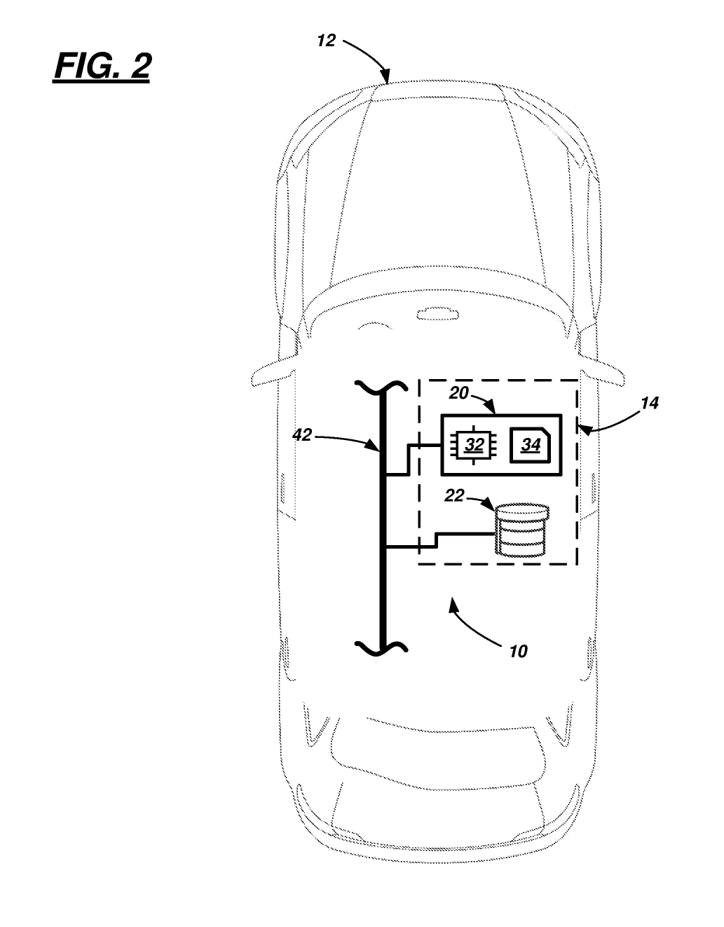

As shown in FIG. 2, computer 20 may comprise at least one processor 32 (one is shown) and memory 34. Processor 32 may be programmed to process and/or execute digital instructions to carry out at least some of the tasks described herein. Non-limiting examples of processor 32 include a microprocessor, a microcontroller or controller, an application specific integrated circuit (ASIC), etc.—just to name a few. A non-limiting example of digitally-stored instructions—storable in memory 34 and executable by processor 32—includes, to: parse a grid-tree data structure for a plurality of previously-evaluated elevation points; determine that none of the plurality are within a radius of a currently-evaluated elevation point; and then, generate a new segment comprising the currently-evaluated elevation point. Other examples of instructions which may be used instead of and/or in addition to these examples, as well as sequences of instructions, are described in the one or more processes below.

Memory 34 may include any non-transitory computer usable or readable medium, which may include one or more storage devices or articles. Exemplary non-transitory computer usable storage devices include conventional hard disk, solid-state memory, random-access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 34 may store one or more computer program products which may be embodied as software, firmware, or other programming instructions executable by the processor 32.

The one or more depth-detection devices 22 (e.g., one is shown) may comprise any suitable electronic device configured to receive ranging measurements (e.g., a range or distance between device 22 and a physical object within the device's line-of-sight (LOS)). Further, device 22 provides such measurements to computer 20 for analysis—e.g., namely, so that vehicle 12 can identify the shape, position and nature of the physical object and thereafter navigate around or relative to said physical object. Of course, device 22 concurrently may provide depth-detection data for numerous physical objects relative to vehicle 12 (e.g., not just the single object shown in FIG. 1).

In some examples, device 22 may execute pre-processing of point-cloud or other sensor data—and then provide it to computer 20. In other examples, no pre-processing occurs, and so-called raw data is provided to computer 20. In the discussion that follows, device 22 is described as a light detection and ranging (LIDAR) device which provides point-cloud data; however, it should be appreciated that this is merely one example. Radar and other depth-detecting devices could be used instead; similarly, data other than point-cloud data could be presented to computer 20.

LIDAR device 22 may be positioned in any suitable location on vehicle 12; e.g., in FIG. 1, the LIDAR device 22 is shown atop a roof 38; this is an example (e.g., non-limiting examples of other locations include the A-pillars, a rear vehicle door, a vehicle grill, etc.). LIDAR device 22 may scan a region around vehicle 12 and detect physical objects 40 within a line-of-sight (LOS) of vehicle 12. In FIG. 1, the physical object 40 is another vehicle; however, this is merely an example. LIDAR device 22 may scan any suitable physical object 40 having two- or three-dimensional physical properties (e.g., from the point-of-view of the device 22). As will be appreciated by skilled artisans, in the LIDAR example, device 22 receives reflectance data having relatively high-depth resolution (e.g., when compared to other commercially-available alternatives); depth data received by a LIDAR device is also referred to herein as point-cloud data. And as referred to herein, a collection of this point-cloud data is a point-cloud data set. Further, each point of the point-cloud data is referred to herein as an elevation point. Each elevation point may include relative coordinate parameters, a timestamp, and/or other information. Coordinate parameters may be defined by a spherical coordinate system, a Cartesian coordinate system, or the like. LIDAR device components and construction, point-cloud data received from a LIDAR device, and LIDAR scanning techniques will not be described in greater detail, as these aspects and techniques will be appreciated by skilled artisans.

As will be explained more below, in at least one example, computer 20 may determine for each elevation point whether the current elevation point is within a predetermined distance from previously-evaluated elevation points (using a vantage-point tree data structure implemented using instructions executable by computer 20). As used herein, a currently-evaluated elevation point is an elevation point currently being evaluated by computer 20 for the purpose of segmentation and/or determining or resolving a virtual object. And as used herein, a previously-evaluated elevation point is an elevation point previously, similarly resolved with respect to the virtual object. More particularly, computer 20 may determine whether the currently-evaluated elevation point is within the predetermined distance of only previously-evaluated elevation points (using a grid-tree data structure implemented using instructions executable by computer 20). For example, as explained below, a grid-tree data structure may include a hash map of depth data (e.g., which depth data comprises one or more depth-data packets). As used herein, each depth-data packet may be an object data structure and comprises the coordinate parameters of a previously-evaluated elevation point, as well as a segment identifier which points to a segment of the virtual object. As used herein, a segment may comprise a single previously-evaluated elevation point or an aggregation of previously-evaluated elevation points which are arranged as a portion of a common virtual object (i.e., being representative of at least a portion of the virtual object being scanned). Put differently, a plurality of aggregated segments may comprise the virtual object.

Turning again to FIG. 2, the diagram illustrates that computer 20 and LIDAR device 22 may be configured for wired and/or wireless electronic communication via a network connection 42. Network connection 42 may include one or more of a controller area network (CAN) bus, Ethernet, Local Interconnect Network (LIN), a fiber optic connection, or the like—just to name a few non-limiting examples. According to one example, which may be used alternatively or in combination with the illustrated bus example, connection 42 comprises one or more discrete wired or wireless connections.

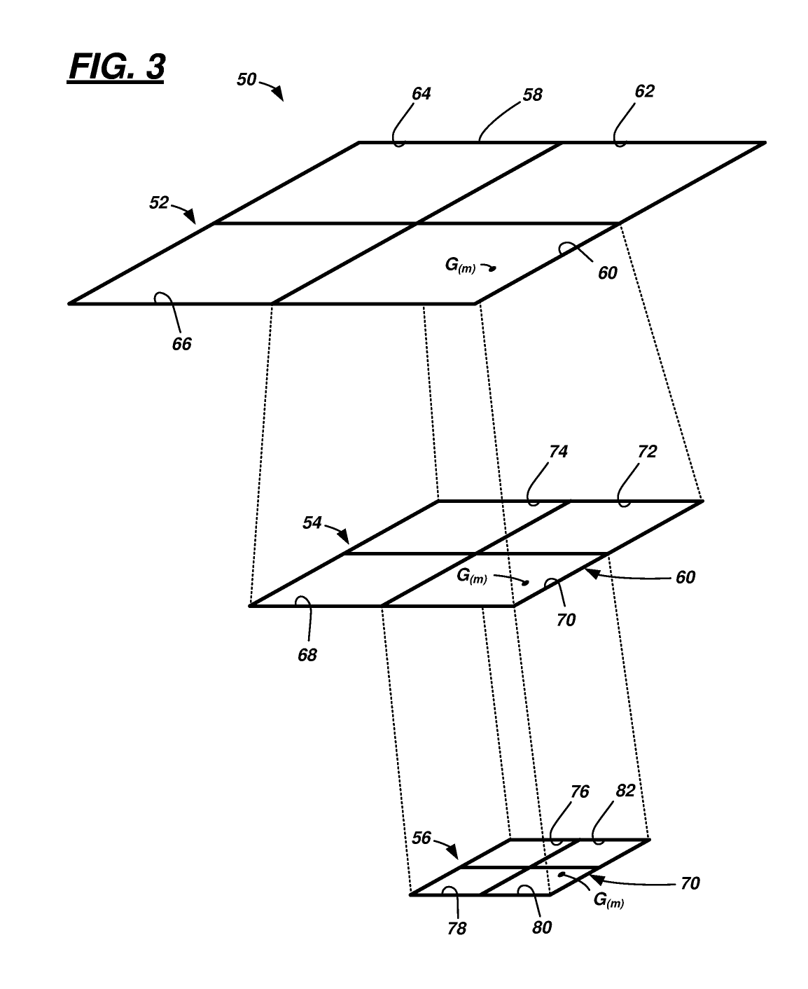

FIGS. 3-7 are schematic diagrams illustrating exemplary data structures which can be stored in memory 34 and which can be used by processor 32 to perform the segmentation described herein. These data structures are illustrated and/or used by way of example only—e.g., to assist in describing a process of depth-data segmentation shown in FIG. 8. Each diagram and aspects thereof are discussed below.

FIG. 3 illustrates an exemplary grid-tree data structure 50 comprising multiple levels 52, 54, 56. Of course, while three are shown, any suitable quantity of levels may be used. Each level 52-56 may comprise a plurality of nodes. For example, level 52 comprises a root node 58 and a plurality of child nodes 60, 62, 64, 66 within that root node 58 (e.g., as well as all of the nodes of each of child nodes 60-66). In this example, the grid-tree data structure 50 is a quad-tree data structure; thus, each parent node (e.g., such as root node 58) comprises four child nodes (e.g., in this case, nodes 60-66).

A quad-tree data structure is a data structure in which each internal node has exactly four child nodes. Quad-tree data structures can be considered a two-dimensional analog of an octree or oct-tree data structure. A quad-tree data structure implementation is merely one example; other grid-tree data structure examples may be used instead.

Accordingly, in the illustrated example, in level 54, child node 60 may comprise a plurality of child nodes 68, 70, 72, 74 (e.g., as well as all of the nodes of each of child nodes 68-74). And accordingly, in level 56, child node 70 may comprise a plurality of child nodes 76, 78, 80, 82 (e.g., as well as all of the nodes of each of child nodes 76-82—e.g., here, none are shown). Thus, if the grid-tree data structure 50 were extended further, each child node 76-82 could have a plurality of child nodes as well.

Each node may store one more depth-data packets—e.g., one depth-data packet G₍ₘ₎ is shown for purposes of illustration only. In FIG. 3, depth-data packet G₍ₘ₎ is part of node 58, node 60, node 70, and node 80. Thus, using such a grid-tree data structure, computer 20 may quickly locate depth-data packet G₍ₘ₎ therein, as described below.

According to known grid-tree data structure techniques, each node may store a threshold quantity of data (e.g., a threshold quantity of depth-data packets), and when the quantity of data in the respective node exceeds the quantity, the computer 20 may be programmed to split the node into child nodes. Other aspects of grid-tree data structures, such as other configuration rules and protocols, will be appreciated by skilled artisans.

Where a node in the grid-tree data structure 50 has no child node, it may be referred to herein as a leaf node. Thus, by way of example in FIG. 3, child node 80 may be a leaf node. Also, as used herein, when any node comprises at least one depth-data packet, it is referred to as an occupied node. And as used herein, when any node comprises no depth-data packets (e.g., it is at least not-yet populated), it is referred to as an empty node. Thus, a currently-evaluated elevation point need only be evaluated with respect to the previously-evaluated elevation points of the occupied nodes (e.g., instead of evaluating all occupied and empty nodes). Thus, using this hybrid vantage-point tree data structure/grid-tree data structure approach, computer-processing may be more efficient thereby improving a vehicle passenger's driving experience.

According to an object-oriented technique, each depth-data packet G₍ₘ₎ may comprise a parsable key and a set of values, as shown in Example (1) below. Accordingly, computer 20 can issue a put( ) command (e.g., according to known hashcode techniques) to store the depth data of a currently-evaluated elevation point as a depth-data packet in the hash map of the grid-tree data structure 50—e.g., for use in the process described below. Further, computer 20 can execute a get( ) command (e.g., also according to known hashcode techniques) later to retrieve the depth-data packet, as also described below. Here, the coordinate parameters are shown as Cartesian coordinate values; however, this is merely an example.

depth-data packet=(parsable key,x-coordinate value,y-coordinate value,segment identifier) Example (1)

In Example (1) and as discussed above, the parsable key may be a hash value. As used herein, a hash value may be a numerical value (e.g., a decimal, binary, hexadecimal, etc. value) having a fixed length and may be used for purposes of uniquely identifying its respective depth-data packet. According to at least one example, the hash value is a numeric value smaller than the collectively corresponding x- and y-coordinate values and segment identifier—e.g., so that by using the hash value, computer 20 may more quickly parse large amounts of depth data and more quickly identify the desired depth-data packet.

In the description that follows, it should be appreciated that data from the LIDAR device 20 may comprise an x-coordinate value, a y-coordinate value, and a z-coordinate value. For purposes of clarity (and not intending to be limiting), the description that follows uses an illustrative example of x- and y-coordinate values and omits discussion of z-coordinate values. However, both two-dimensional and three-dimensional implementations exist.

According to one example, the x- and y-coordinate values refer to a depth position in a field of view of the LIDAR device 22. Accordingly, based on a position and/or orientation of the LIDAR device 22 on vehicle 12 and using known alignment techniques, computer 20 can determine a relative position of the physical object 40 with respect to the vehicle 12.

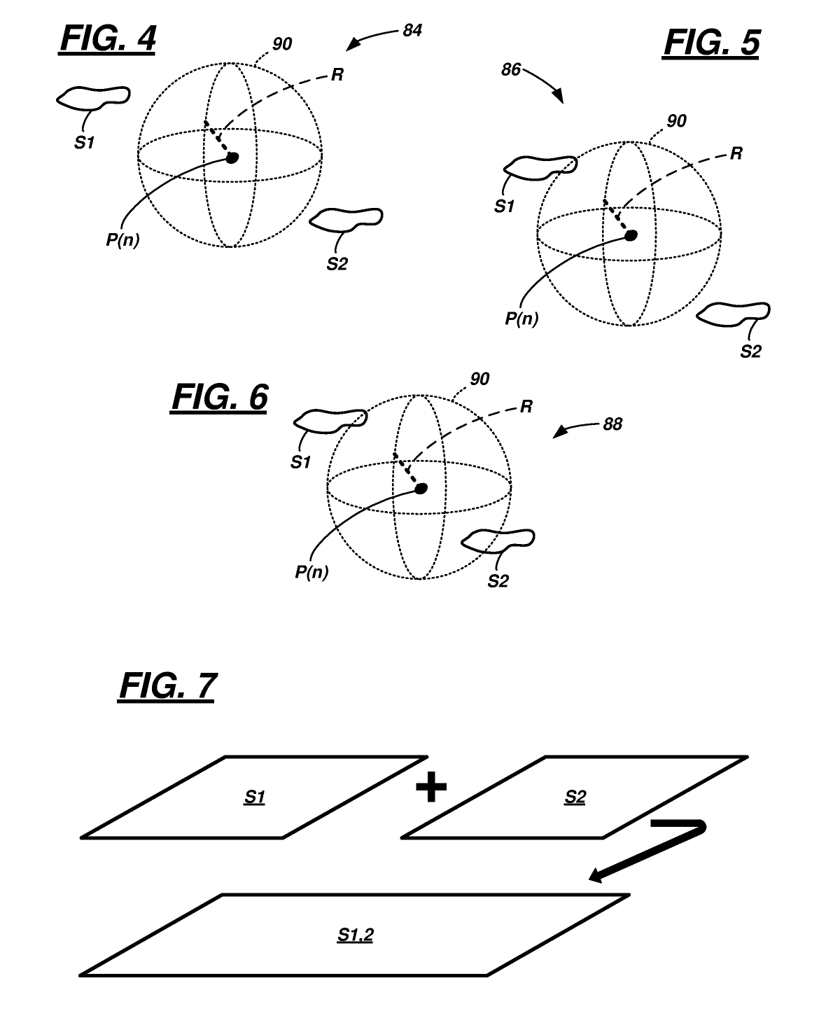

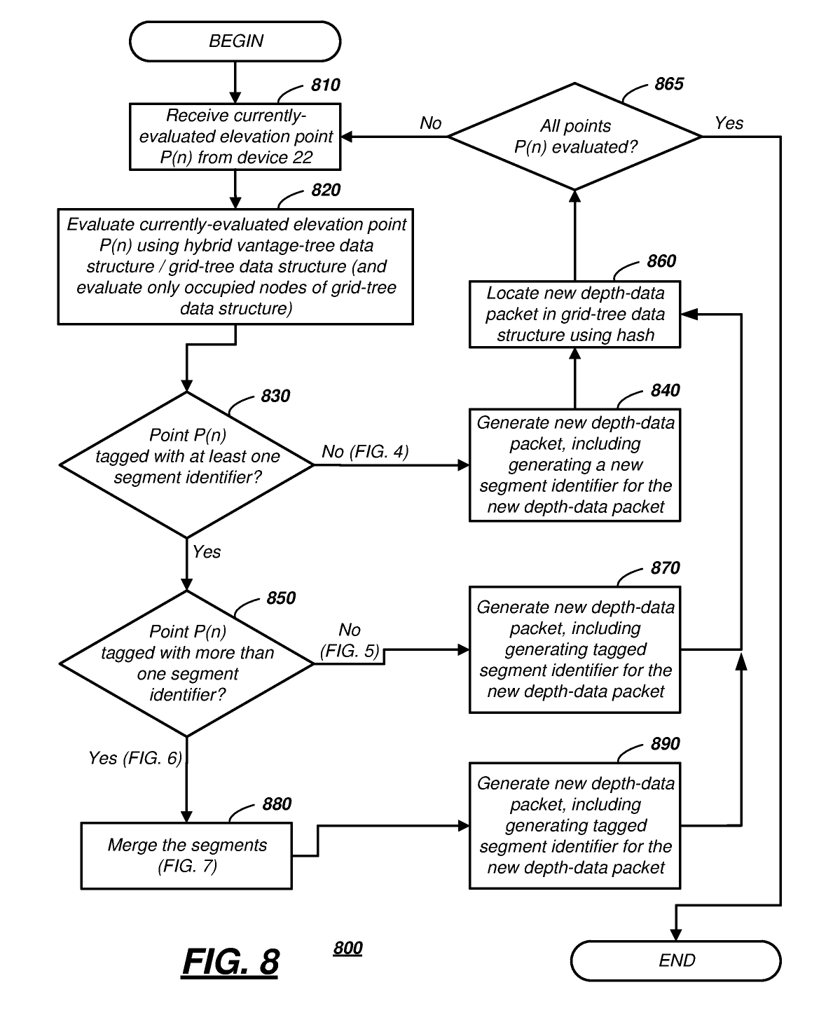

FIGS. 4-6 each illustrate exemplary vantage-point tree data structures 84, 86, 88, respectively. For example, each structure 84, 86, 88 illustrates a currently-evaluated elevation point P(n) of a point-cloud data set, two exemplary segments S1, S2, and a radius R extending radially outwardly from point P(n) (e.g., accordingly defining a spherical region 90). According to an aggregation process described herein, elevation points P(n) are tagged with a segment identifier based on their proximity (e.g., within radius R) to the respective segment.

According to one example, the value of radius R may be predetermined (e.g., stored in memory 34). In other examples, radius R may be determined on a case-by-case basis while vehicle 12 is moving—e.g., based on the distance of the physical object 40 from the device 22 (e.g., radius R being larger for physical objects which are farther away, and radius R being smaller for physical objects which are closer). Also, it should be appreciated that the value of radius R may be determined based on a value which will not undesirably merge virtual objects together, when the corresponding physical objects are separate and distinct. To illustrate, consider two different vehicles (scanned by device 22) driving side-by-side—having a spacing between them. It would be desirable to set the value of R to be less than this spacing so that the computer 20 does not consider the two vehicles driving side-by-side to be a single vehicle.

According to the example shown in FIG. 4, neither segment S1 or S2 are within radius R—e.g., they are outside the bounds of the spherical region 90. In this example, currently-evaluated elevation point P(n) would not be tagged with a segment identifier since neither segment S1 nor segment S2 intersect the spherical region 90. As described below, if no segments were within the radius R, then the currently-evaluated elevation point P(n) would be tagged with a new and unique segment identifier (e.g., being the first point associated with that particular segment).

According to the example shown in FIG. 5, the currently-evaluated elevation point P(n) is within radius R of segment S1, and currently-evaluated elevation point P(n) is not within radius R of segment S2—e.g., only segment S1 intersects with the spherical region 90. As described below, in this example, currently-evaluated elevation point P(n) will be tagged only with an identifier of segment S1.

And according to the example shown in FIG. 6, currently-evaluated elevation point P(n) is within radius R of both segments S1 and S2—e.g., both segments S1 and S2 at least partially intersect spherical region 90. As used herein, when a segment is within the radius R (or intersects the spherical region 90) it means that at least one elevation point of the respective segment is within radius R distance of the currently-evaluated elevation point P(n). As described below, in this example, the two segments S1 and S2 will be merged (by computer 20) into a single segment (S1,2) and the currently-evaluated elevation point P(n) will be tagged with an identifier of the newly-merged segment S1,2. Further, all of the previously-evaluated elevation points associated with segment S1 and segment S2 will be re-tagged (by computer 20) with the segment identifier of segment S1,2. As used herein, the term tag or tagging refers to using computer 20 to associate one data element with another via the processor 32 and/or memory 34 (e.g., to store a segment or segment identifier with an elevation point so that when retrieved later, computer 20 reads the elevation point as being aggregated with the respective segment).

A schematic example of the newly-merged segment S1,2 is shown in FIG. 7. As will be explained more below, computer 20 combines these segments (S1 and S2) to form a larger portion of the virtual object scanned by LIDAR device 22 in accordance with the process of segmentation. And computer 20 continues the process described above until a representation of the virtual object is formed by adding points to existing segments, generating new segments, and merging two or more segments together.

Turning now to FIG. 8, an exemplary segmentation process 800 is shown—e.g., for generating a virtual object based on scanned physical object 40. As discussed above, the process 800 utilizes a hybrid technique—e.g., using a vantage-point tree data structure (e.g., 84, 86, 88) and a grid-tree data structure (e.g., 50) in order to increase computational speed of determining the virtual object—e.g., thereby resolving physical objects faster (than without the process), resolving physical objects with greater depth resolution (than without the process), resolving more physical objects during a common period of time (than without the process), or a combination thereof. In general, process 800 may comprise a plurality of instructions shown in FIG. 8 and described below as logic blocks. Further, process 800 is iterative—e.g., typically blocks 810-890 or any combination thereof are repeated to execute segmentation.

Process 800 may begin with block 810 wherein computer 20 receives a currently-evaluated elevation point P(n) from LIDAR sensor 22. As described above, the currently-evaluated elevation point P(n) may comprise at least x-coordinate and y-coordinate values (e.g., referred to below as x(n) and y(n), respectively).

In block 820 which follows, computer 20 may evaluate currently-evaluated elevation point P(n) using the hybrid vantage-point tree/grid-tree data structure techniques discussed above. More particularly, computer 20 may parse a hash map of the grid-tree data structure 50 to identify only the occupied nodes and may retrieve the depth-data packets stored therein (e.g., using the get( ) command). Thus, by not parsing the empty nodes (i.e., by not parsing all nodes), computer 20 may reduce the time spent searching the grid-tree data structure 50.

Coordinate values for each previously-evaluated elevation point may be retrieved by computer 20 using respective parsable keys to locate depth-data packets in the grid-tree data structure 50. Thus, by using the parsable keys associated with each depth-data packet G₍ₘ₎, time spent searching may be further minimized (e.g., as computer 20 need not search every data element in the grid-tree data structure 50).

Continuing with block 820, for each retrieved depth-data packet G₍ₘ₎, computer 20 may evaluate the currently-evaluated elevation point P(n) to see if any previously-evaluated elevation points are within the radius R (of point P(n)). More particularly, computer 20 may perform this evaluation using Equation (1) below.

Distance D₍ₘ₎=\sqrt{[x(n)−x₍ₘ₎]²+[y(n)−y₍ₘ₎]²}, Equation (1)
wherein x₍ₘ₎ is the x-coordinate value retrieved from the respective depth-data packet G₍ₘ₎ and y₍ₘ₎ is the corresponding y-coordinate value retrieved from the respective depth-data packet G₍ₘ₎.

For sake of illustration, a first depth-data packet G₍₁₎ may comprise: a parsable key₍₁₎, the x-coordinate value x₍₁₎, the y-coordinate value y₍₁₎, and a segment identifier S₍₁₎. Thus, computer 20 may compare radius R with distance D₍₁₎. When distance D₍₁₎≤R, then P(n) may be considered part of segment S1, and computer 20 may tag point P(n) with segment identifier S₍₁₎. Furthermore, in these instances, when computer 20 identifies another depth-data packet comprising segment identifier S₍₁₎ [during this iteration], computer 20 may skip evaluating Equation (1) with respect to that depth-data packet—as it was previously determined that P(n) is part of segment S1. This also may increase processing efficiency.

Other the other hand, when distance D₍₁₎>R, then P(n) is determined to not be within segment S1, and computer 20 may skip to a next depth-packet data retrieved from the grid-tree data structure 50.

Continuing with the example above, this parsing process may be repeated for a second depth-data packet G₍₂₎. Packet G₍₂₎ may comprise: a parsable key₍₂₎, the x-coordinate value x₍₂₎, the y-coordinate value y₍₂₎, and a segment identifier S₍₂₎. Thus, computer 20 may calculate distance D₍₂₎ and compare radius R with distance D₍₂₎. The evaluation of the second depth-data packet G₍₂₎ may be similar to that discussed above with respect to packet G₍₁₎; therefore, it will not be re-described in its entirety. For purposes of illustration of process 800, consider an example wherein distance D₍₂₎ is greater than R. Similar to that described above, computer 20 may determine that P(n) also is considered part of segment S2, and computer 20 may tag P(n) with segment identifier S₍₂₎.

This parsing process may continue until each depth-data packet G₍ₘ₎ in the grid-tree data structure 50 has been evaluated or considered with respect to point P(n). Accordingly, in some instances, currently-evaluated elevation point P(n) may not be tagged with a segment identifier (e.g., meaning none of the depth-data packets comprised previously-evaluated elevation points which were within a radius R of P(n)); or point P(n) may be tagged with one segment identifier (e.g., meaning only one of the depth-data packets comprised a previously-evaluated elevation point which was within a radius R of P(n)); or point P(n) may be tagged with multiple segment identifiers (e.g., meaning multiple depth-data packets comprised respective previously-evaluated elevation points which were within a radius R of P(n)). Once all depth-data packets G₍ₘ₎ of data structure 50 have been evaluated, process 800 may continue to blocks 830-890.

Blocks 830-890 illustrate a process-flow based on the number of segment identifiers tagged to currently-evaluated elevation point P(n) in block 820. For example, block 830 determines whether any segment identifiers were tagged. If no segment identifier was determined for point P(n), then process 800 proceeds to block 840 (e.g., see representation shown in FIG. 4). If at least one segment identifier was determined for point P(n), the process 800 proceeds to block 850 (e.g., see representations shown in FIG. 5 and FIG. 6).

In block 840, computer 20 generates a new depth-data packet for the currently-evaluated elevation point P(n). This may include computer 20 generating a new (unique) segment identifier for currently-evaluated elevation point P(n) and tagging point P(n) with the newly-generated segment. Further, computer 20 may generate a new parsable key (a new hash) for the new depth-data packet. Thus, the new depth-data packet may comprise a new parsable key, the x-coordinate value of point P(n), the y-coordinate value of point P(n), and the new segment identifier. Thereafter, process 800 proceeds to block 860.

In block 860, computer 20 may use the new parsable key and the put( ) command to locate the new depth-data packet within the grid-tree data structure 50. In this manner, in the future, this new depth-data packet may be retrieved by computer 20 and used to evaluate future currently-evaluated elevation points.

Following block 860, the process may proceed to block 865. In block 865, computer 20 may determine whether additional elevation points P(n) are available for evaluation. If additional points P(n) are available, process 800 may loop back to block 810 and repeat at least a portion of the process 800. If no additional points P(n) are available, process 800 may end.

Returning now to block 850 (which follows block 830 in some instances), here computer 20 determined that currently-evaluated elevation point P(n) was tagged with at least one segment identifier. In block 850, computer 20 determines whether point P(n) was tagged with only one segment identifier or whether point P(n) was tagged with multiple segment identifiers. If point P(n) was tagged with only one segment identifier, then process 800 proceeds to block 870. And if point P(n) was tagged with more than one segment identifier, the process 800 proceeds to block 880.

In block 870, computer 20 generates a new depth-data packet in a manner similar to that described above (in block 840); however here, computer 20 stores the single segment identifier tagged to point P(n) instead of generating a new segment identifier. Furthermore, computer 20 generates a new parsable key, as described above. Following block 870, process 800 may proceed to block 860 (repeating the instruction thereof) and ultimately to block 810 (or end).

Returning now to block 880 (which follows block 850 in some instances), here computer 20 determined that currently-evaluated elevation point P(n) was tagged with more than one segment identifier. In block 880, based on point P(n) being within a radius R of two or more segments (e.g., segment S1 and S2), computer 20 determines that these (e.g., two) segments therefore must form part of the same virtual object. Accordingly, in block 880, computer 20 merges these two segments into a single segment (e.g., segment S1,2, as illustrated in FIG. 7). In this manner, reconstruction of the virtual object may occur more quickly—e.g., this merger thus enables the efficiencies discussed above with respect to future currently-evaluated elevation points P(n) being within a radius R of any of the elevation points tagged with segment identifier S_{(1,2)}. Block 880 also may comprise updating each of the depth-data packets tagged with segment identifier S₍₁₎ and segment identifier S₍₂₎ with newly-merged segment identifier S_{(1,2)}.

Thus, process 800 utilizes both grid-tree data structure techniques and vantage-point data structure techniques. This enables a more seamless way to merge segments. Further, this hybrid technique results in fewer artifacts than with traditional methods.

Process 800 was merely one example, and other examples exist. According to one alternative example, the imaging system 14 is utilized on structures other than vehicle 12. For example, the imaging system 14 may be used without autonomous driving system 10. In fact, the structure to which the depth-detection device is coupled can be movable or stationary (e.g., such as a building or other infrastructure).

Thus, there has been described an imaging system that comprises a computer and a depth-detection device. According to one example, the device provides computer point-cloud data, and the computer is programmed to execute a segmentation process. The process utilizes both a grid-tree data structure and vantage-point tree data structure.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method, comprising:
parsing a grid-tree data structure for a plurality of previously-evaluated elevation points;
determining that none of the plurality are within a radius of a currently-evaluated elevation point; and then,
generating a new segment comprising the currently-evaluated elevation point.

2. The method of claim 1, wherein the plurality and the currently-evaluated elevation point are received from a light detection and ranging device.

3. The method of claim 1, further comprising: adding the new segment to the grid-tree data structure.

4. The method of claim 1, further comprising generating a depth-data packet that comprises a parsable key, an x-coordinate value and a y-coordinate value of the currently-evaluated elevation point, and a segment identifier of the new segment.

5. The method of claim 4, further comprising locating the depth-data packet into the data structure using the parsable key, wherein the data structure comprises a hash map.

6. The method of claim 1, wherein each of the plurality comprise: a hash value, an x-coordinate value, a y-coordinate value, and a segment identifier.

7. The method of claim 1, wherein the data structure is a quad-tree data structure.

8. A method, comprising:
parsing a grid-tree data structure for a plurality of previously-evaluated elevation points;
determining that one of the plurality are within a radius of a currently-evaluated elevation point, wherein the one comprises a first segment identifier; and then,
tagging the currently-evaluated elevation point with the first segment identifier.

9. The method of claim 8, wherein the plurality and the currently-evaluated elevation point are received from a light detection and ranging device.

10. The method of claim 8, further comprising generating a depth-data packet that comprises a parsable key, an x-coordinate value and a y-coordinate value of the currently-evaluated elevation point, and the first segment identifier.

11. The method of claim 10, further comprising locating the depth-data packet into the data structure using the parsable key, wherein the data structure comprises a hash map.

12. The method of claim 8, wherein each of the plurality comprise: a hash value, an x-coordinate value, and a y-coordinate value, wherein at least one of the plurality includes the first segment identifier.

13. The method of claim 8, wherein the parsing comprises processing only occupied nodes.

14. The method of claim 8, wherein the data structure is a quad-tree data structure.

15. A method, comprising:
parsing a grid-tree data structure for a plurality of previously-evaluated elevation points;
determining that a first point and a second point of the plurality are within a radius of a currently-evaluated elevation point, wherein the first point comprises a first segment identifier, wherein the second point comprises a second segment identifier;
merging segments associated with the first and second points; and
adding the currently-evaluated elevation point and a new identifier of the merged segment to the data structure.

16. The method of claim 15, wherein the plurality and the currently-evaluated elevation point are received from a light detection and ranging device.

17. The method of claim 15, further comprising generating a depth-data packet that comprises a parsable key, an x-coordinate value and a y-coordinate value of the currently-evaluated elevation point, and the new identifier.

18. The method of claim 17, further comprising locating the depth-data packet into the data structure using the parsable key, wherein the data structure comprises a hash map.

19. The method of claim 15, wherein each of the plurality comprise: a hash value, an x-coordinate value, and a y-coordinate value, wherein others of the plurality include a third segment identifier that is different from the first and second identifiers.

20. The method of claim 15, wherein the parsing comprises processing only occupied nodes.
